(19) United States
(12) Patent Application Publication
(10) Pub. No.: US 2013/0255073 A1
(43) Pub. Date: Oct. 3, 2013

(54) METHOD FOR MANUFACTURING SEALED CELL

(71) Applicant: SANYO ELECTRIC CO., LTD., Moriguchi City (JP)

(72) Inventors: Hiroshi Hosokawa, Kasai City (JP); Haruhiko Yamamoto, Takasago City (JP)

(73) Assignee: Sanyo Electric Co., Ltd., Moriguchi City (JP)

(21) Appl. No.: 13/848,306

(22) Filed: Mar. 21, 2013

(30) Foreign Application Priority Data
Mar. 30, 2012 (JP) 2012-081034

(51) Int. Cl. H01M 2/02

(52) U.S. Cl. CPC H01M 2/02
USPC 29/623.2

(57) ABSTRACT

A method for manufacturing a sealed cell includes the step of welding the joint between an outer can and a sealing body by applying high-energy radiation. Grooves are formed on the outer peripheral surface of the sealing body and/or a portion of the inner peripheral surface of the outer can, the portion facing the outer peripheral surface of the sealing body, the grooves being communicated with at least one of inside and outside the cell. A groove-forming region is formed of a plurality of the grooves having widths of 70 to 600 μm and spacings of 70 to 600 μm therebetween. The welding step applies the beam so that the deepest part of a melting section formed when the materials of the outer can and of the sealing body are melted by the beam can be located below the upper ends of the grooves forming the groove-forming region.

### BACKGROUND OF THE INVENTION

1. Field of the Invention

The present invention relates to a method for manufacturing a sealed cell, and more particularly, to a method for weld-sealing the outer can with a sealing body.

2. Background Art

Prismatic sealed cells have been used as power sources for driving various electronic devices because they can be easily installed therein.

Such a sealed cell is manufactured by joining a sealing body to the opening of the outer can, and welding the joint using high-energy radiation such as laser beam. In this method, insufficient weld strength may cause cracks in the welded spot when the cell is dropped or subjected to other impact. The cracks may cause leakage of the electrolytic solution, and entry of oxygen or moisture into the cell, thereby reducing cell performance.

One approach to solving these problems is to improve the weld strength by increasing laser beam intensity, and hence, increasing the penetration depth of the laser beam. This approach, however, leads to generation of spatters and early deterioration of laser devices.

Some techniques for cell laser welding are shown in Patent Documents 1-3.

Patent Document 1: Japanese Unexamined Patent Publication No. 2001-185099

Patent Document 2: Japanese Unexamined Patent Publication No. 2011-204396

Patent Document 3: Japanese Unexamined Patent Publication No. 2007-157519

According to the technique of Patent Document 1, first, a lid having at least one recess on its side surfaces is put in the opening of the cell can. Next, the cell can is pressed from its outer surface, so that the wall of the cell can is locked into the recess of the lid and then laser-welded together. This technique is said to facilitate and ensure the joint between the lid and the opening of the sealed cell.

According to the technique of Patent Document 2, notches are formed on at least one of the outer peripheral edge of a sealing plate and the opening edge of an outer can. Laser welding is applied along a notch groove, which is formed along the boundary between the opening edge of the outer can and the outer peripheral edge of the sealing plate. When the outer peripheral edge of the sealing plate is joined to the opening edge of the outer can, the facing inner surfaces of the notch groove are connected to each other by a melted connection part. As a result, the bottom of the notch groove is not welded, thereby providing a non-welded gap. This technique is said to effectively prevent the generation of blow-holes in the welded spot, thereby firmly fixing the sealing plate to the opening of the outer can.

The welding technique of Patent Document 3 includes a first step and a second step. The first step is to prepare an outer can having an opening, and a sealing plate including a flange having grooves formed around a part or the entire perimeter of its surface to be joined with the outer can, and to insert the sealing body into the opening of the outer can in such a manner that the top surface of the outer can and the top surface of the flange of the sealing plate are substantially flush with each other. The second step is to weld the joint between the opening of the outer can and the sealing plate by applying high-energy radiation. This technique is said to provide a sealed cell in which the welded joint has a high strength.

FIGS. 7A and 7B show a conventional method for weld-sealing a cell when the joint has a small gap; FIG. 7A shows the joint unwelded and FIG. 7B shows the joint being welded. FIGS. 8A and 8B show the conventional method for weld-sealing a cell when the joint has a large gap; FIG. 8A shows the joint unwelded, and FIG. 8B shows the joint being welded. Laser welding, however, has the following problem. If the joint between the outer can 1 and the sealing body 2 has a large gap as shown in FIG. 8A, the gap cannot be fully filled with a molten material. As a result, as shown in FIG. 8B, undercuts 5 are generated in a melting section 3, thereby causing the weld strength to be insufficient. If the gap is reduced as shown in FIG. 7A to solve the problem, this in turn inhibits the discharge of gas 4 from the melting section 3. The gas 4 is generated when the heat of the laser beam evaporates the material of the outer can 1 or of the sealing body 2, or deposits on or around the joint. As a result, as shown in FIG. 7B, the gas 4 is left as holes inside a melted-solidified region, which is the result of the solidification of the melting section 3. The presence of these holes causes the weld strength to be insufficient. The techniques shown in Patent Documents 1-3 make no reference to this problem.

### SUMMARY OF THE INVENTION

The present invention has an object of providing a method for manufacturing a sealed cell that is tightly weld-sealed without causing holes or undercuts.

To solve the above-described problems, the present invention has the following configuration.

The method of the present invention for manufacturing a sealed cell includes the step of welding the joint between an outer can and a sealing body by applying high-energy radiation. In this method, a plurality of grooves are formed on the outer peripheral surface of the sealing body and/or a portion of the inner peripheral surface of the outer can, the portion facing the outer peripheral surface of the sealing body, the grooves being communicated with at least one of inside and outside the cell; and a groove-forming region is formed of a plurality of the grooves having widths of 70 to 600 μm and spacings of 70 to 600 μm therebetween. The step of welding is a step of applying the high-energy radiation in such a manner that the deepest part of a melting section formed when the materials of the outer can and of the sealing body are melted by the high-energy radiation can be located below the upper ends of the grooves forming the groove-forming region.

The advantages of the above configuration will now be described with reference to drawings. FIGS. 1A and 1B show a method of the present invention for weld-sealing a cell; FIG. 1A is a longitudinal sectional view of the joint, and FIG. 1B shows the joint seen through from the front surface of an outer can 1. Gas 4 generated by the heat of the laser beam can smoothly move to the inside and/or the outside of the cell along grooves 10 shown in FIG. 1B. The grooves 10 are communicated with at least one of inside and outside the cell (in FIG. 1B, both inside and outside). This significantly prevents the gas 4 generated by the heat of the laser beam from staying and solidifying in a melting section 3, or in other words, significantly prevents the generation of holes in a melted-solidified region. The gap between the outer can 1 and the sealing body 2 is large only in the portions corresponding to the grooves 10, and is small in the remaining portions. This ensures the flow of the molten material into the grooves 10, thereby preventing undercuts or other welding defects. As a result, the sealed cell can be tightly weld-sealed. The grooves 10 located in the melted-solidified region are completely filled with the molten material, leaving no traces of themselves.

To ensure the pathways of the gas 4, the grooves 10 need only be communicated with at least one of inside and outside the cell, but more preferably are communicated with both of them. The phrase “to be communicated with at least one of inside and outside the cell” indicates the following cases. First, when the grooves 10 are formed on the sealing body 2, the grooves 10 are communicated with at least one of the upper and lower ends of the sealing body 2. Next, when the grooves 10 are formed on the outer can 1 in such a manner as to be communicated with inside the cell, the grooves 10 need to be formed beyond the lower end of the sealing body 2. This is because if the grooves 10 are merely communicated with the lower end of the sealing body 2, the pathways of the gas 4 may not lead to the inside of the cell. Finally, when the grooves 10 are formed on the outer can 1 in such a manner as to be communicated with outside the cell, the grooves 10 need only either to be communicated with the opening end of the outer can 1, or to be formed beyond the upper end of the sealing body 2.

The deepest part of the melting section 3, which is formed when the materials of the outer can 1 and of the sealing body 2 are melted by the high-energy radiation, need to be located below the upper ends of the grooves 10. The reason for this is as follows. If the upper ends of the grooves 10 are located below the deepest part of the melting section 3, the generated gas 4 cannot move to the inside and the outside of the cell along the grooves 10.

The following is a description of groove-forming regions “A” with reference to FIGS. 5A and 5B. FIGS. 5A and 5B are a plan view and a front conceptual view, respectively, of the groove-forming regions “A” (A1-A4). Assume, as shown in FIG. 5B, that n grooves 10₁ to 10ₙ are formed on the outer peripheral surface of the sealing body 2, and that the grooves 10₁ to 10ₙ are spaced from each other with n−1 space regions p₁ to pₙ₋₁ therebetween. Then, a region surrounded by the grooves 101 to 10ₙ is referred to as a groove-forming region “A” upon the satisfaction of all of the following conditions: the grooves 10₁ to 10ₙ have widths l₁ to lₙ of 70 to 600 μm; adjacent ones of the grooves 10₁ to 10ₙ are spaced from each other with spacings lₚ₁ to lₚₙ₋₁ of 70 to 600 μm; and the distance from the groove 10ₙ to the groove 10₁ on the periphery of the joint surface (within this distance, the grooves 10₂ to 10ₙ₋₁ are not located) is either less than 70 μm or more than 600 μm.

Assume that the width of the groove 10ₓ where 1<x<n is either less than 70 μm or more than 600 μm, and that the widths and spacings of the other grooves are in the above-mentioned ranges. Then, there are two groove-forming regions “A”: one region surrounded by the grooves 10₁ to 10ₓ₋₁, and the other region surrounded by the grooves 10ₓ₊₁ to 10ₙ. Similarly, assume that the spacing l_{py} where 1<y<n−1 is either less than 70 μm or more than 600 μm, and that the widths and spacings of the other grooves are in the above-mentioned ranges. Then, there are two groove-forming regions “A”: one region surrounded by the grooves 10₁ to 10_{y}, and the other region surrounded by the grooves 10_{y+1} to 10ₙ. Assume that the distance from the groove 10ₙ to the groove 10₁ on the periphery of the joint surface (within this distance, the grooves 10₂ to 10ₙ₋₁ are not located) is 70 to 600 μm, and that the widths and spacings of the other grooves are in the mentioned ranges. Then, a single groove-forming region “A” is formed around the entire periphery of the surface of the joint.

The method of the present invention maximizes the advantages of the grooves 10 because in a groove-forming region “A”, the grooves having the widths l₁ to lₙ of 70 to 600 μm are densely arranged with the spacings lₚ₁ to lₚₙ₋₁ of 70 to 600 μm.

The groove-forming region “A” does not necessarily need to be formed around the entire periphery of the surface of the joint. In the case where the method of the present invention is applied to a prismatic sealed cell, it is desirable to form the groove-forming regions A1-A4 at the corners of the cell as shown in FIG. 5A because holes tend to be formed there.

The widths and spacings of the grooves 10 can be either equal to or different from each other within the above-mentioned ranges. Furthermore, a single groove 10 may vary in width.

The grooves 10 may be formed by any method such as by being pressed with a roller having a rough surface. The grooves 10 can be formed on the outer peripheral surface of the sealing body 2 and/or a portion of the inner peripheral surface of the outer can 1, the portion facing the outer peripheral surface of the sealing body 2. It is desirable to form the grooves 10 on the outer peripheral surface of the sealing body 2 because of the ease of formation.

Problems such as the generation of undercuts or holes are remarkable when the outer can 1 and the sealing body 2 are made of aluminum-based material such as pure aluminum or aluminum alloy. However, the method of the present invention can achieve a light-weight cell including aluminum components but not having problems of undercuts or holes.

The present invention is applicable to not only cells in which the outer can and the sealing body are entirely made of aluminum-based material, but also cells in which only the portion to be welded of the outer can and the portion to be welded of the sealing body are made of aluminum-based material. More specifically, the present invention is applicable to cells in which the sealing body has an electrode terminal and a resin gasket in its vicinity; and cells in which the outer can is insulation-coated.

Specific examples of the aluminum-based material include Japanese Industrial Standards (JIS) 1000 series pure aluminum and 3000 series aluminum-manganese alloy.

Specific examples of the high-energy radiation include electron beam and laser beam, of which laser beam is more preferable.

The grooves 10 can be inclined with respect to the thickness direction of the sealing body 2.

If the grooves 10 are parallel to the thickness direction of the sealing body 2, the high-energy radiation such as laser beam may directly enter the cell through the grooves 10 and cause damage to power generation components stored inside the cell. This problem can be prevented by making the grooves 10 inclined with respect to the thickness direction of the sealing body 2. As shown in FIG. 2A, the high-energy radiation has an angle of incidence θ1 of 10 to 22 degrees although it may vary depending on the setting of the optical system. Hence, when the angles θ2 and θ3 (see FIGS. 2A and 2B, respectively) formed by the direction in which the grooves 10 are inclined from its side facing the inside of the cell toward its side facing the outside of the cell, and the thickness direction of the sealing body 2 can be preferably 30 to 80 degrees to prevent the high-energy radiation from directly entering the cell through the grooves 10. The angles θ2 and θ3 are more preferably 40 to 70 degrees.

In welding using high-energy radiation as shown in FIGS. 3A and 3B, the melting section 3 is deepest at the focus of the high-energy radiation and is shallower toward the periphery. Assume that the direction in which the grooves 10 are inclined from its side facing the inside of the cell toward its side facing the outside of the cell, and the proceeding direction of the high-energy radiation welding are opposite to each other as shown in FIG. 3B. Then, the gas 4 generated in the melting section 3 can be discharged only to the inside of the cell because the pathways to the outside of the cell are buried. In contrast, when the inclination direction of the grooves 10 and the proceeding direction of the high-energy radiation welding are equal to each other as shown in FIG. 3A, the gas 4 generated in the melting section 3 can be desirably discharged to both the inside and outside of the cell.

It is desirable that the total length of the groove-forming regions “A” be 40% or more of a joint line 20. It is also desirable that the total width of the grooves 10 be 20% or more of the joint line 20. For example, in the case where there are four groove-forming regions A1-A4 having lengths of L_{A1} to L_{A4}, respectively, as shown in FIG. 5A, it is desirable to satisfy a relation of L_{A1}+L_{A2}+L_{A3}+L_{A4}≧0.4×L1. It is also desirable that the total width of the grooves 10 on the joint line 20 be equal to or larger than the value of 0.2×L1. As shown in FIG. 5A, the joint line 20 indicates a line appearing when the joint between the sealing body 2 and the outer can 1 is viewed two dimensionally, or indicates the outer peripheral line of the sealing body 2 based on the assumption that the outer peripheral surface of the sealing body 2 does not have asperities formed by the presence of the grooves 10. The widths and spacings of the grooves 10, and the lengths of the groove-forming regions “A” (A1-A4) are along the joint line 20.

If a single groove 10 varies in width, or if the grooves 10 do not have the same inclination angle, thereby not having the same spacing therebetween, the above-mentioned ranges may be applied only to the widths and spacings of those grooves 10 and those groove-forming regions “A” which correspond to the deepest part of the melting section 3. The deepest part of the melting section 3 is predetermined, for example, by applying high-energy radiation to the sealing body 2 and the outer can 1 at the same power level as for the welding or performing a simulation.

The lengths of the grooves 10 in the thickness direction of the sealing body 2 is preferably 50% or more of the thickness of the sealing body 2, and more preferably 70% or more of it.

As described above, the method of the present invention can effectively prevent the generation of holes or undercuts in the melted-solidified region 6, which is the result of the sealing body 2 being welded to the outer can 1, thereby providing a sealed cell with excellent sealing property and high ruggedness.

### BRIEF DESCRIPTION OF DRAWINGS

FIGS. 1A and 1B show a method of the present invention for weld-sealing a cell; FIG. 1A is a longitudinal sectional view of a joint, and FIG. 1B shows the joint seen through from the front surface of the outer can.

FIGS. 2A and 2B show the relationship between the inclination angles of grooves and the angle of incidence of a laser beam; FIG. 2A shows the case of a small inclination angle, and FIG. 2B shows the case of a large inclination angle.

FIGS. 3A and 3B show the relationship between the inclination direction of the grooves and the proceeding direction of a laser beam; FIG. 3A shows the case of these directions being equal to each other, and FIG. 3B shows the case of these directions being opposite to each other.

FIGS. 4A and 4B show the relationship between the communication direction of the grooves and the discharge direction of gas; FIG. 4A shows the case of the grooves being communicated with the upper end of a sealing body, and FIG. 4B shows the case of the grooves being communicated with the lower end of the sealing body.

FIGS. 5A and 5B show groove-forming regions; FIG. 5A is a plan view of the groove-forming regions, and FIG. 5B is a front conceptual view of the groove-forming regions.

FIG. 6 is a perspective view of a sealed cell manufactured according to the present invention.

FIGS. 7A and 7B show a conventional method for weld-sealing a cell when the joint has a small gap; FIG. 7A shows the joint unwelded and FIG. 7B shows the joint being welded.

FIGS. 8A and 8B show the conventional method for weld-sealing a cell when the joint has a large gap; FIG. 8A shows the joint unwelded, and FIG. 8B shows the joint being welded.

### DESCRIPTION OF THE INVENTION

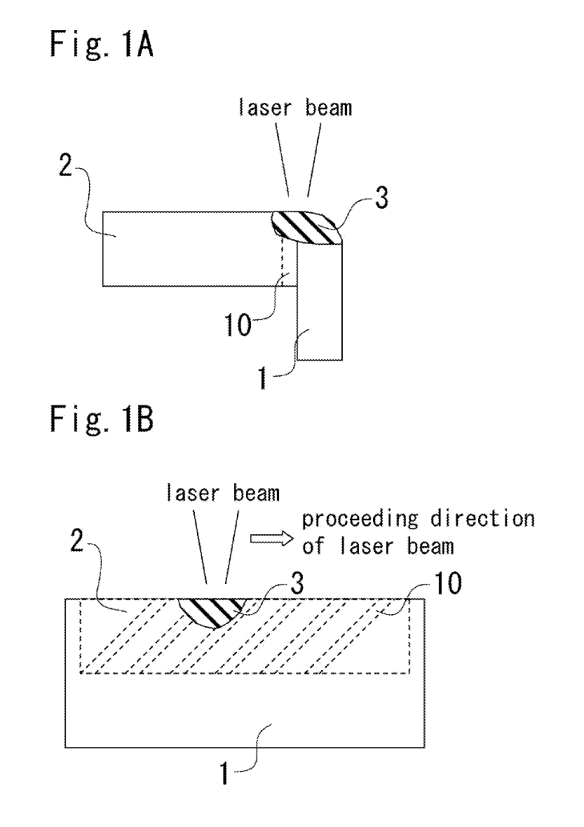

An embodiment of the present invention will be described in detail with reference to drawings as follows. FIGS. 1A and 1B show a method of the present invention for weld-sealing a cell; FIG. 1A is a longitudinal sectional view of the joint, and FIG. 1B shows the joint seen through from the front surface of the outer can 1.

According to the method of the present invention, a cell is manufactured by joining a sealing body 2 to the opening of an outer can 1, and welding the joint using a laser beam as shown in FIGS. 1A and 1B. The sealing body 2 has a plurality of grooves 10 on its outer peripheral surface. The grooves 10 are communicated with the upper and lower ends of the sealing body 2. As a result, the deepest part of a melting section 3, which is formed when the materials of the outer can 1 and of the sealing body 2 are melted by the laser beam, is located below the upper ends of the grooves 10.

This allows the gas 4 generated by the heat of the laser beam to smoothly move into or out of the cell through the grooves 10 during laser sealing. Thus, the gas 4 generated by the heat of the laser beam in the melting section 3 does not stay there, but moves into or out of the cell. This significantly prevents the generation of holes in a melted-solidified region 6, which is the result of the solidification of the melting section 3. The gap between the sealing body 2 and the outer can 1 is large only in the portions corresponding to the grooves 10, and is small in the remaining portions. This ensures the flow of the molten material into the grooves 10, thereby preventing undercuts and other welding defects. Thus, the method of the present invention does not have the above-described problems caused by the conventional welding methods.

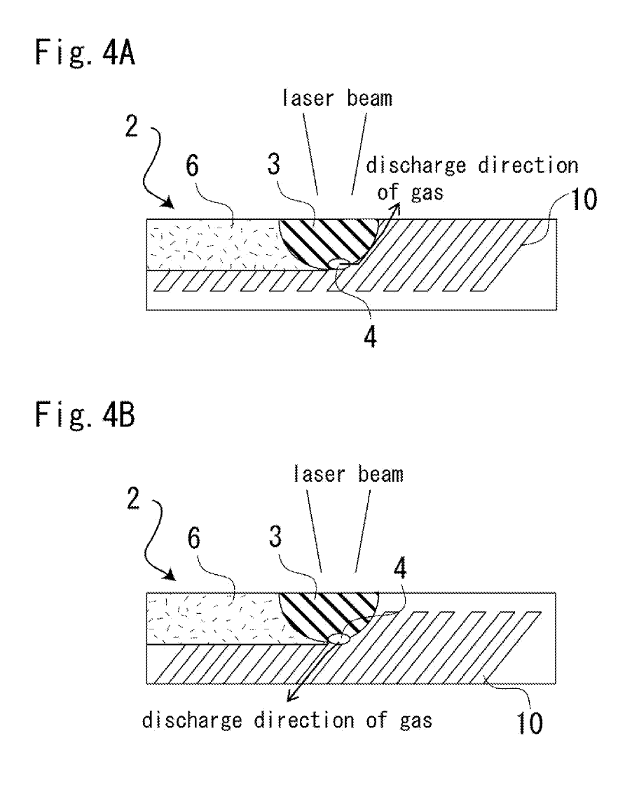

As shown in FIGS. 4A and 4B, the pathways of the gas 4 are ensured if the grooves 10 are communicated with at least one of the upper and lower ends of the sealing body 2 (in other words, communicated with at least one of inside and outside the cell). Thus, the grooves 10 do not necessarily need to be communicated with both the upper and lower ends of the sealing body 2. However, as shown in FIG. 4B, the upper ends of the grooves 10 need to be located above the deepest part of the melting section 3, which is formed when the materials of the outer can 1 and of the sealing body 2 are melted by the laser beam.

The depths of the grooves 10 are preferably 10 to 100 μm, and more preferably, 10 to 30 μm to efficiently prevent the generation of holes and undercuts. In the case where the grooves 10 formed on both the sealing body 2 and the outer can 1 overlap each other, it is desirable to limit the total depth of the grooves 10 to the above-mentioned ranges.

The widths of the grooves 10 are set to 70 to 600 μm because of the following reasons. With too small a width, the gas 4 may not easily be discharged. On the other hand, too large a width may cause welding defects because a large amount of welding is applied to the portions corresponding to the grooves 10 where the gap between the outer can 1 and the sealing body 2 is large.

The spacings between the grooves 10 (the distances between adjacent ones of the grooves 10) are also set to 70 to 600 μm because of the following reasons. With too large a spacing, the gas 4 may not easily be discharged. On the other hand, too small a distance may cause welding defects because a large amount of welding is applied to the portions corresponding to the grooves 10 where the gap between the outer can 1 and the sealing body 2 is large.

The grooves 10 may have different widths and depths from each other, and different spacings therebetween, but preferably have the same size and spacing therebetween to perform uniform welding.

The cross section of the grooves 10 is not particularly limited, and can be of various shapes such as a rectangle, a trapezoid, a square, a V shape, a U shape, a semi-circle, or a semi-oval.

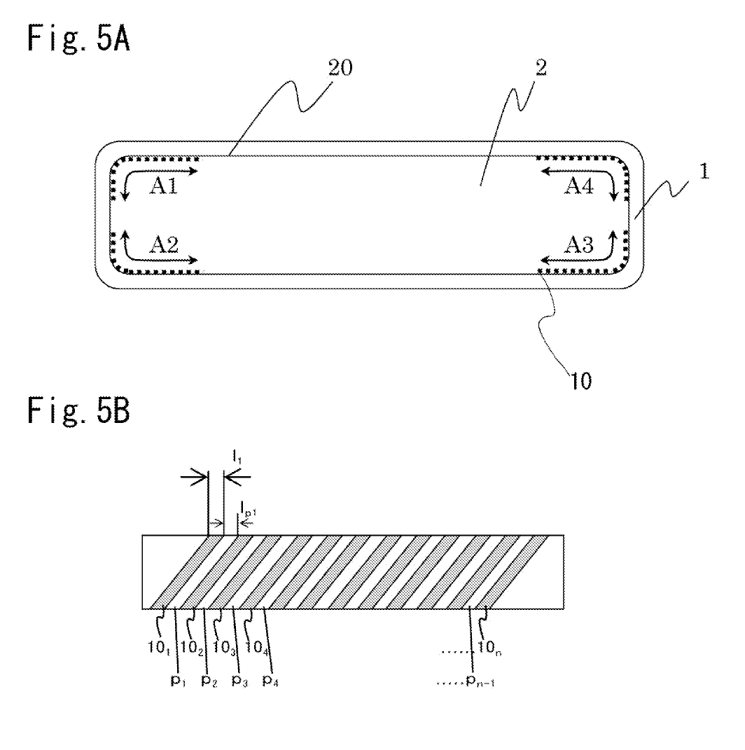

The following is a description of the groove-forming regions “A” with reference to FIGS. 5A and 5B. FIGS. 5A and 5B are a plan view and a front conceptual view, respectively, of the groove-forming regions A1-A4. Assume, as shown in FIG. 5B, that n grooves 10₁ to 10ₙ are formed on the outer peripheral surface of the sealing body 2, and that the grooves 10₁ to 10ₙ are spaced from each other with n−1 space regions p₁ to pₙ₋₁ therebetween. Then, a region surrounded by the grooves 10₁ to 10ₙ is referred to as a groove-forming region “A” upon the satisfaction of all of the following conditions: the grooves 10₁ to 10ₙ have widths l₁ to lₙ of 70 to 600 μm; adjacent ones of the grooves 10₁ to 10ₙ are spaced from each other with spacings lₚ₁ to lₚₙ₋₁ of 70 to 600 μm; and the distance from the groove 10ₙ to the groove 10₁ on the periphery of the joint surface (within this distance, the grooves 10₂ to 10ₙ₋₁ are not located) is either less than 70 μm or more than 600 μm.

Assume that the width of the groove 10ₓ where 1<x<n is either less than 70 μm or more than 600 μm, and that the widths and spacings of the other grooves are in the above-mentioned ranges. Then, there are two groove-forming regions “A”: one region surrounded by the grooves 10₁ to 10ₓ₋₁, and the other region surrounded by the grooves 10ₓ₊₁ to 10ₙ. Similarly, assume that the spacing l_{py} where 1<y<n−1 is either less than 70 μm or more than 600 μm, and that the widths and spacings of the other grooves are in the above-mentioned ranges. Then, there are two groove-forming regions “A”: one region surrounded by the grooves 10₁ to 10_{y}, and the other region surrounded by the grooves 10_{y+1} to 10ₙ. Assume that the distance from the groove 10n to the groove 10₁ on the periphery of the joint surface (within this distance, the grooves 10₂ to 10ₙ₋₁ are not located) is 70 to 600 μm, and that the widths and spacings of the other grooves are in the mentioned ranges. Then, a single groove-forming region “A” is formed around the entire periphery of the surface of the joint.

As shown in FIG. 5A, the joint line 20 indicates a line appearing when the joint between the sealing body 2 and the outer can 1 is viewed two dimensionally, or indicates the outer peripheral line of the sealing body 2 based on the assumption that the outer peripheral surface of the sealing body 2 does not have asperities formed by the presence of the grooves 10. In the case where there are four groove-forming regions A1-A4 having lengths of L_{A1} to L_{A4}, respectively, on the joint line 20 as shown in FIG. 5A, and where the joint line 20 has a length of L1, it is desirable that the groove-forming regions A1-A4 have a total length: L_{A1}+L_{A2}+L_{A3}+L_{A4}, which is equal to or larger than the value of 0.4×L1. It is also desirable that the total width of the grooves 10 on the joint line 20 be equal to or larger than the value of 0.2×L1.

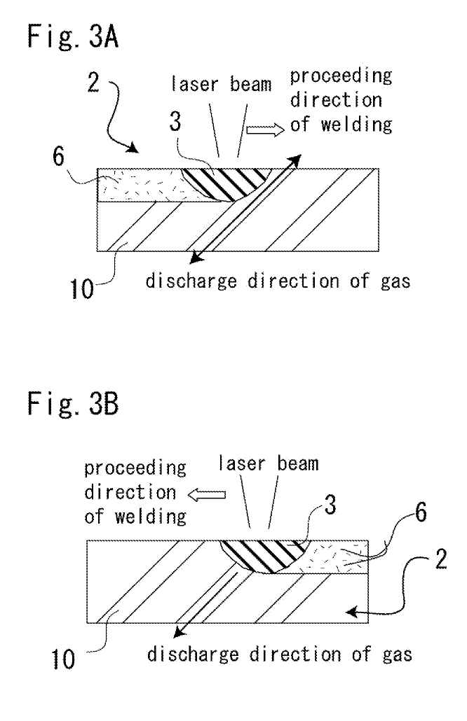

The grooves 10 are preferably inclined with respect to the thickness direction of the sealing body 2. In this case, the inclination angle and the inclination direction may differ for each of the grooves 10. It is, however, desirable that the proceeding direction of laser welding (or the laser scanning direction) and the inclination direction of the grooves 10 (when viewed from inside the cell) are equal to each other as shown in FIG. 3A. If these directions are opposite to each other as shown in FIG. 3B, the gas can be discharged only through the lower ends of the grooves 10.

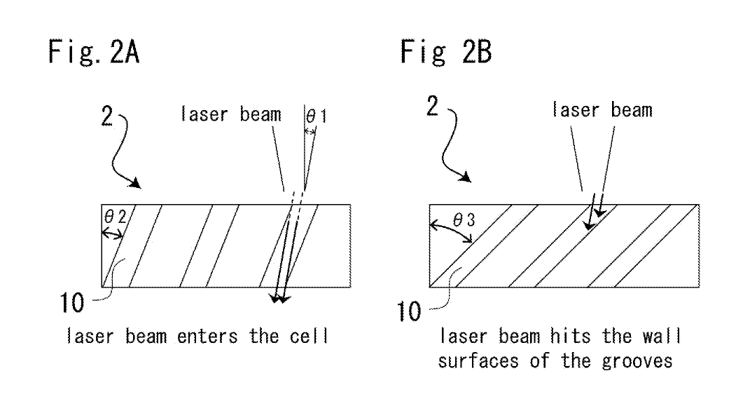

As shown in FIG. 2A, in the case where the grooves 10 have a small inclination angle θ2 between the inclination direction of the grooves 10 and the thickness direction of the sealing body, the laser beam may directly enter the cell through the grooves 10. To avoid this problem, it is preferable that the grooves 10 have a large inclination angle θ3 as shown in FIG. 2B so that the regions between adjacent ones of the grooves 10 can block the laser beam from entering the cell. The laser beam has an angle of incidence θ1 of 10 to 22 degrees, although it may vary depending on the setting of the optical system. The angle between the inclination direction of the grooves 10 and the thickness direction of the sealing body 2 is preferably 30 to 80 degrees, and more preferably 40 to 70 degrees.

### (Additions)

The method of the present invention for manufacturing a sealed cell is applicable to all types of cells including primary and secondary cells which are sealed by high-energy radiation welding. The present invention is particularly suitable to large size prismatic cells with a capacity of 5 Ah or more because these cells tend to cause holes or undercuts during extensive welding in a short time.

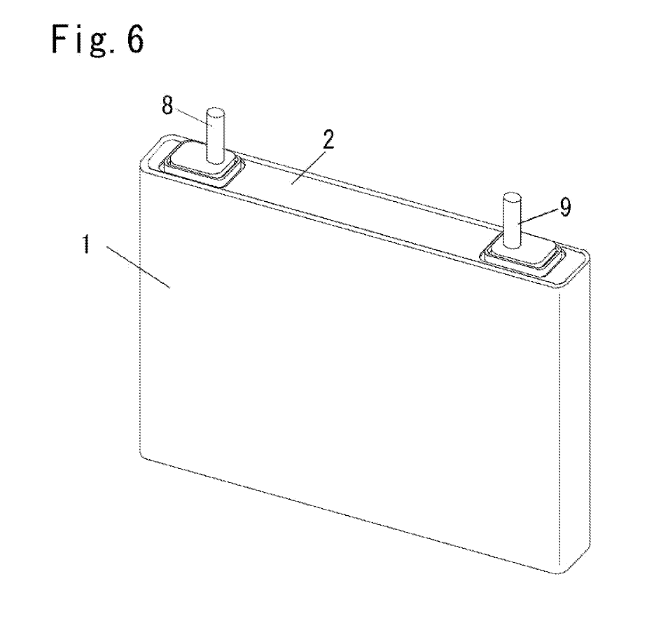

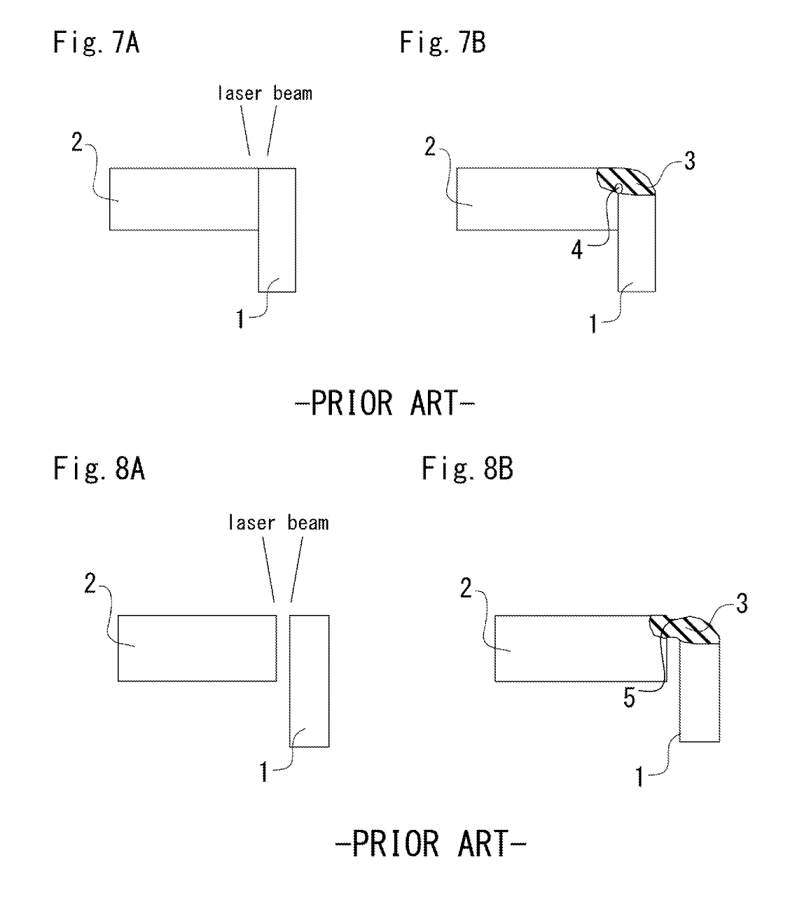

The outer can 1 and the sealing body 2 may have a function as electrode external terminals. In the example shown in FIG. 6, however, the outer can 1 and the sealing body 2 do not function as electrode external terminals; instead, there are provided electrode external terminals 8 and 9 projecting from the sealing body 2 while being isolated from the sealing body 2. The configuration shown in FIG. 6 can be easily applied to large size cells. In this configuration, the positive-electrode external terminal 8 and the negative-electrode external terminal 9 are fixed to the sealing body 2 while being isolated from the sealing body 2 via an insulating member.

The present invention can use as the high-energy radiation welding, any known welding methods such as pulse laser welding, continuous wave (CW) laser welding, or electron beam welding.

In the above description, the grooves 10 are formed on the outer peripheral surface of the sealing body 2. Alternatively, the grooves 10 may be formed on a portion of the inner peripheral surface of the outer can 1, the portion facing the outer peripheral surface of the sealing body 2, or be formed on both of these surfaces. In the case of forming the grooves 10 on both of these surfaces, the spacings between the grooves 10 indicate those on the joint line 20 between the sealing body 2 and the outer can 1, and do not indicate the spacings on the outer peripheral surface of the sealing body 2 or on the inner peripheral surface of the outer can 1.

The sealing body 2 and the outer can 1 may be made of iron, iron alloy, iron or iron alloy plated with something else, stainless steel, or the like, instead of aluminum-based material.

As described above, the method of the present invention can manufacture a sealed cell that is tightly weld-sealed, providing high industrial applicability.

### Reference Marks in the Drawings

1 outer can
2 sealing body
3 melting section
4 gas
5 undercut
6 melted-solidified region
8 positive-electrode external terminal
9 negative-electrode external terminal
10 groove
A groove-forming region
p space region between grooves

What is claimed is:

1. A method for manufacturing a sealed cell, the method comprising the step of:
welding a joint between an outer can and a sealing body by applying high-energy radiation, wherein
a plurality of grooves are formed on an outer peripheral surface of the sealing body and/or a portion of an inner peripheral surface of the outer can, the portion facing the outer peripheral surface of the sealing body, the grooves being communicated with at least one of inside and outside the cell; and
a groove-forming region is formed of a plurality of the grooves having widths of 70 to 600 μm and spacings of 70 to 600 μm therebetween,
wherein the step of welding is a step of applying the high-energy radiation in such a manner that a deepest part of a melting section formed when a material of the outer can and a material of the sealing body are melted by the high-energy radiation can be located below upper ends of the grooves forming the groove-forming region.

2. The method of claim 1, wherein
the outer can and the sealing body are both made of aluminum-based material.

3. The method of claim 1, wherein
the outer can and the sealing body do not function as electrode external terminals.

4. The method of claim 1, wherein
the grooves are inclined with respect to a thickness direction of the sealing body.

5. The method of claim 4, wherein
a direction in which the grooves are inclined from a side thereof facing the inside of the cell toward a side thereof facing the outside of the cell is equal to a proceeding direction of the high-energy radiation welding.

6. The method of claim 4, wherein
an angle formed by the inclination direction of the grooves and the thickness direction of the sealing body is 30 to 80 degrees.

7. The method of claim 1, wherein
a total length of the groove-forming regions is 40% or more of a length of a joint line.

8. The method of claim 1, wherein
a total width of the grooves is 20% or more of a joint line.
